(19) United States
(12) Patent Application Publication
(10) Pub. No.: US 2016/0168307 A1
(43) Pub. Date: Jun. 16, 2016

(54) METHOD FOR PRODUCING POLYOXYMETHYLENE DIMETHYL ETHERS FROM FEEDSTOCK OF CONCENTRATED FORMALDEHYDE

(71) Applicants: Dongfang Hongsheng New Energy Application Technology Research Institute Co., Ltd, Beijing (CN); Jiangsu Kaimao Chemical Technology Co., Ltd, Wuxi City (CN); China University Of Petroleum (Eastern China), Tsingdao (CN)

(72) Inventors: Hongyan SHANG, Tsingdao (CN); Zhengpeng HONG, Beijing (CN); Zimao YE, Wuxi City (CN); Jiayong XIANG, Wuxi City (CN); Zhenzhen XUE, Tsingdao (CN)

(73) Assignees: Dongfang Hongsheng New Energy Application Technology Research Institute Co., Ltd, Beijing (CN); Jiangsu Kaimao Chemical Technology Co., Ltd, Wuxi City (CN); China University Of Petroleum (Eastern China), Tsingdao (CN)

(21) Appl. No.: 14/965,571

(22) Filed: Dec. 10, 2015

(30) Foreign Application Priority Data
Dec. 12, 2014 (CN) 201410771125.4

(51) Int. Cl. C08G 16/02

(52) U.S. Cl. CPC C08G 16/0225

(57) ABSTRACT

The present invention pertains to the technical field of energy resource chemical industry, and in particular relates to a process for producing polyoxymethylene dimethyl ethers by directly using concentrated formaldehyde aqueous solution as feedstock to catalytically react with methanol and/or methylal in a fixed bed reactor. The method of the present invention uses concentrated formaldehyde aqueous solution with a concentration of over 80% by weight to react with methanol and/or methylal, in the presence of an acidic catalyst, to produce the required polyoxymethylene dimethyl ethers. As compared with using paraformaldehyde powder as feedstock, the method of the present invention accelerates the depolymerization process of paraformaldehyde, thus significantly reduces the time required for product synthesis and makes the synthesis reaction able to be carried out in a fixed bed reactor; meanwhile, as compared with using formaldehyde aqueous solution with a low concentration as feedstock, the method of the present invention also significantly increases the yield rate of the target product.

### TECHNICAL FIELD

The present invention pertains to the technical field of energy resource chemical industry, and in particular relates to a process for producing polyoxymethylene dimethyl ethers by using concentrated formaldehyde aqueous solution together with methanol and/or methylal as feedstock to react in a fixed bed reactor.

### BACKGROUND OF THE INVENTION

Recent investigation shows that, the apparent consumption of diesel fuel in China has already mounted up to about 167 million tons, which leads to frequent occurrence of short supply of diesel fuel (the domestic demand ratio of diesel fuel to petrol is about 2.5:1, but the production ratio thereof is about 2.3:1). Besides the reasons of unreasonable pricing of different types of oil products, and slow price linkage mechanism of domestic petroleum products with international crude oil, the fundamental reason is the restriction of resource shortage. Traditionally, diesel fuel is made from petroleum feedstock, and the resource endowment of China characterized in relatively “rich in coal, poor in oil, and lack in gas” leads to increasingly prominent contradiction between petroleum supply and relatively fast sustainable development of economics and society. Since the year 1993 when China became a net importer of petroleum, the import volume has been increasing fast and constantly, and the foreign-trade dependence already surpassed 56% after 2011, which has a severe influence on national strategic security of energy.

Therefore, in consideration of national strategic security of energy, resource endowment and the realistic structure of primary energy production, it is strategically important without doubt to develop synthesis technology of non-petroleum based liquid fuel. The coal resource is relatively rich in China, with a recoverable reserve of about 700 billion tons of standard coal, which can be utilized for about 200 years if estimated according to an annual total energy demand of 3-4 billion tons of standard coal per year. This resource endowment of “rich in coal, poor in oil, and lack in gas” determines that, in the next decades, the production and consumption structure of primary energy in China is going to be mainly coal in a long term, severely deviating from the world primary energy consumption mainstream structure of mainly petroleum and gas, which is a fundamental reason to drive R&D and industrialization of synthesis technology of non-petroleum based, especially coal based, liquid fuel and bulk chemicals during recent years. As a strategic technological reserve for liquid fuel made from coal, industrial tests of coal direct liquefaction technology have already passed technical appraisement, however, the coal direct liquefaction technology requires huge investment and needs improvement and perfection in terms of process, engineering and equipments, and the oil product quality still has defects such as high aromatic hydrocarbon content and low cetane number. Coal indirect liquefaction technology is mature and run by large factories around the world from early on, with a long product chain and a large market volume, and is able to develop over 200 types of various oil products and high value-added chemical products based on its liquefaction equipments. However, it is not a technique to produce a leading product of diesel fuel, and it relates to a capital intensive and technology intensive industry with 10-12 thousand RMB of investment per ton of oil product which requires large-scale and intensified operation of at least 3 million tons per year. The domestic R&D and industrialization of coal indirect liquefaction technology has gained considerable progress during recent years.

Furthermore, the worsening of crude oil quality leads to continuous scale expansion of domestic catalytic processing of heavy oil and increasing percentage of diesel fuel produced by catalytic processing, which results in gradual decrease of the cetane number (CN value) of diesel fuel products and significant increase of noxious substance discharged after combustion, therefore, the urgent problem to be solved is to increase the CN value of diesel fuel.

The tail gas discharged by a diesel engine contains a large amount of noxious substance such as unburned hydrocarbon compounds and particulate matter (PM), as well as CO, CO₂ and NOₓ, which are one of the main sources of PM2.5 contamination in urban air. International Agency for Research on Cancer (IARC) affiliated to World Health Organization (WHO) declared in June, 2012 the decision to elevate the cancer hazard ranking of diesel engine tail gas, from “possibly carcinogenic” classified in 1988 to “definitely carcinogenic”. As scientific research advances, now there is enough evidence to prove that diesel engine tail gas is one of the reasons that cause people to suffer from lung cancer. Furthermore, there is also limited evidence indicating that, inhaling diesel engine tail gas is relevant to suffering from bladder cancer. People come into contact with diesel engine tail gas through various channels in daily life and work. IARC hopes that this reclassification can provide reference for national governments and other decision makers, so as to actuate them to establish more strict discharge standards of diesel engine tail gas. This significant decision undoubtedly puts forward harsher requirements of diesel fuel quality.

Reducing the content of noxious substance such as sulfur, nitrogen and aromatic hydrocarbon in fuels by petroleum refining process such as hydrogenation is an effective technical route to improve fuel quality, but has very demanding requirements for hydrogenation catalyst and reaction process, with relatively high processing cost. Internationally, many scientific research institutes are carrying out R&D on production technologies of oxygen-containing blending components for petrol and diesel fuel, especially those diesel fuel blending components with high oxygen contents and high cetane numbers, and this has recently become a research hotspot in the technical field of new energy.

Research has indicated that, in consideration of inherent characteristics of oxygen-containing fuel, when a oxygen-containing substance with a high cetane number, such as coal-based or methanol-based substance, is added into the fuel as a fuel additive, the discharge of hydrocarbon and CO, especially soot, can be effectively reduced, without changing the original parameters of the engine or increasing the discharge of NOₓ.

So far, a plenty of researches indicate that, polyoxymethylene dimethyl ethers (also named as poly-methoxymethylal, abbreviated as DMMₙ, n=2-8), which has a general formula of CH₃(OCH₂)ₙOCH₃ and is a yellow liquid with a high boiling point, an average cetane number reaching above 63 and increasing dramatically as its polymerization degree increases, an average oxygen content of 47%-50%, a flash point of about 65.5° C., and a boiling point of about 160-280° C., is a type of clean diesel fuel blending component with a high cetane number, and is also a world-recognized environmental friendly fuel component. Polyoxymethylene dimethyl ethers can be blended into diesel fuel to significantly improve the performance of diesel fuel without the need to modify the engine oil feeding system of the in-use vehicle. Polyoxymethylene dimethyl ethers have good environmental protection performance, and when blended into diesel fuel at a certain percentage, they can increase oxygen content of the oil product, and greatly reduce the discharge of contaminants such as unburned hydrocarbon compounds, PM particulate black smoke and CO from vehicle tail gas. Because polyoxymethylene dimethyl ethers have a high cetane number and physical property similar to that of diesel fuel, they are also a type of diesel fuel additive with very high application value.

Synthesis of polyoxymethylene dimethyl ethers may be carried out by processing synthesis gas through a series of steps of methanol, formaldehyde, methylal, polyformaldehyde and dimethyl ether etc. China is a famous huge country of coal storage, and Chinese technologies of producing methanol from coal, producing methanol from natural gas and producing methanol from coke-oven gas are increasingly mature, and the production capacity of methanol broke through 50 million tons in 2012, but the equipment operation rate is merely about 50%, thus the problem of methanol surplus has already become very prominent, and the industrial chain of coal chemical industry is in an urgent need to be further extended. Therefore, developing the technology of producing polyoxymethylene dimethyl ethers from coal-based methanol can not only provide a new technology to significantly increase diesel fuel product quality, but also improve the feedstock structure of diesel fuel production by making it more suitable for the resource endowment of domestic fossil energy, thereby enhancing the strategic security of domestic supply of liquid fuel for engines.

The production process of polyoxymethylene dimethyl ethers should comprise three major process units, wherein, the first unit is a synthesis unit where cascade polymerization reactions and thermodynamic equilibrium reactions catalyzed by acidic catalysts take place; the second unit is a product mixture pretreatment unit where processing steps such as deacidifying by neutralization and dehydration by drying take place; and the third unit is a product rectification and separation unit which attempts to separate polyoxymethylene dimethyl ethers by simple rectification or complicated rectification such as extractive rectification, azeotropic rectification, etc.

It is reported that the already developed process for synthesizing polyoxymethylene dimethyl ethers mostly use trioxane or paraformaldehyde as feedstock. However, it is found in practice that, paraformaldehyde needs to depolymerize before taking part in the reaction, and its depolymerization time is relatively long and increases as its polymerization degree increases, which leads to that the entire reaction requires too long time. Furthermore, as restricted by the reaction time, the entire synthesis reaction has to be carried out in a tank reactor, rather than operating in a fixed bed reactor, which leads to two shortcomings. The first shortcoming is that, the capacity of the entire reaction is limited, and if it is required to increase the capacity, the only option is to increase the number of the tank reactors by significantly increasing the investment. The second shortcoming is that, because the synthesis reaction of polyoxymethylene dimethyl ethers is a reversible reaction, it is easy to reach reaction equilibrium in a tank reactor, causing a low yield rate of the target product, which severely influences the overall gainings. In addition, as the paraformaldehyde feedstock is solid powder, it is not convenient to transport and measure the paraformaldehyde feedstock.

### SUMMARY OF THE INVENTION

Therefore, the technical problem to be solved by the present invention is, when using paraformaldehyde powder as feedstock to produce polyoxymethylene dimethyl ethers in prior art, the time required for the synthesis reaction is relatively long, which leads to limited options for reactor types, and the effective volume required is relatively large, which leads to increased primary investment of equipments. Thus, the present invention provides a method for producing polyoxymethylene dimethyl ethers by using concentrated formaldehyde aqueous solution as feedstock, thereby shortening the time required for the synthesis reaction so as to make it possible to operate with a fixed bed reactor, and also effectively increasing the reaction yield rate.

To solve the above-mentioned technical problem, the present invention provides a method for producing polyoxymethylene dimethyl ethers from feedstock of concentrated formaldehyde aqueous solution, which comprises using formaldehyde aqueous solution with a concentration of over 80% by weight as feedstock to react with methanol and/or methylal, in the presence of an acidic catalyst, to produce the required polyoxymethylene dimethyl ethers.

Preferably, the concentration of the formaldehyde aqueous solution is 85% by weight.

Furthermore, the concentrated formaldehyde aqueous solution is an intermediate product obtained before a spray drying granulation step during manufacturing of paraformaldehyde.

The reaction for producing polyoxymethylene dimethyl ethers is carried out in a fixed bed reactor.

The fixed bed reactor is an adiabatic reactor or a multitubular reactor.

The acidic catalyst is selected from the group consisting of strong acidic cation exchange resin, solid acid catalyst, and molecular sieve based catalyst.

During the reaction, the reaction is carried out at a temperature of 70-200° C., a pressure of 0.1-2.0 MPa, and a space velocity of 0.5-4.0 h⁻¹.

Among the feedstock, the molar ratio of the methanol and/or methylal to the formaldehyde in the concentrated formaldehyde aqueous solution is 1:1 to 1:4.

The reaction is carried out under protection of an inert gas.

The reaction further comprises refining the polyoxymethylene dimethyl ether products.

The aforementioned method of the present invention has the following advantages, as compared to the prior art:

The method for producing polyoxymethylene dimethyl ethers of the present invention uses formaldehyde aqueous solution with a high concentration to replace the commonly used trioxane/paraformaldehyde in prior art as feedstock, with the reaction process being a liquid-liquid reaction, and with a relatively low polymerization degree of formaldehyde in the formaldehyde aqueous solution with a high concentration, thereby significantly shortening the time required for the reaction.

Since the reaction time required for the method of the present invention is relatively short, it is suitable to operate with a fixed bed reactor. The flow pattern of the reaction mixture in a fixed bed reactor is similar to a plug flow, with little back-mixing, so that, under determined operation condition, the total reactor volume required for achieving a determined total yield rate is relatively small, thereby saving primary investment of synthesis reaction equipments.

In the method of the present invention, during deep analysis of the reasons affecting the synthesis reaction rate of the target product, it is found out that the water content of the entire system has great influence on the forward reaction. Experiments have proved that, by using concentrated formaldehyde aqueous solution with a high concentration (85% by weight) as feedstock, as compared with using formaldehyde aqueous solution with a concentration of 37% or 45% by weight presently on the market as feedstock, not only the yield rate is significantly increased and the reaction rate is faster, but also less waste water is produced and the product is easy to separate.

The formaldehyde aqueous solution with a concentration of 85% by weight used by the present invention can be selected to be an intermediate product of the manufacturing process of paraformaldehyde (during the manufacturing process of paraformaldehyde, at first formaldehyde aqueous solution with a concentration of 45% by weight needs to be concentrated to 65% by weight and further to 85% by weight, then spray drying granulation is performed to obtain paraformaldehyde powder with a certain polymerization degree distribution), as compared with the process route of using paraformaldehyde powder as feedstock, not only the spray drying granulation step is avoided, thereby saving equipment investment and operation cost, but also the synthesis of the target product is simplified from a liquid-solid(paraformaldehyde powder)-solid(catalyst) three-phase reaction system into a liquid-solid(catalyst) two-phase reaction system, so that it is more convenient to transport and measure the feedstock.

### DETAILED DESCRIPTION OF EMBODIMENTS

### Embodiment 1

In a multitubular fixed bed reactor, formaldehyde aqueous solution with a concentration of 85% by weight and methylal are supplied with keeping the molar ratio of formaldehyde in the formaldehyde aqueous solution to methylal of 4:1, a nitrogen atmosphere is maintained, with catalytic action of a solid acid catalyst, the reaction is carried out at a temperature of 180-200° C., a pressure of 0.1 MPa, and a space velocity of 0.5 h⁻¹, until reaction equilibrium is reached.

### Embodiment 2

In an adiabatic fixed bed reactor, formaldehyde aqueous solution with a concentration of 85% by weight and methylal are supplied with keeping the molar ratio of formaldehyde in the formaldehyde aqueous solution to methylal at 3:1, a nitrogen atmosphere is maintained, with catalytic action of HP catalyst, the reaction is carried out at an inlet temperature of 150-180° C., an outlet temperature of 180-200° C., a pressure of 1.5 MPa, and a space velocity of 1 h⁻¹, until reaction equilibrium is reached.

### Embodiment 3

In an adiabatic fixed bed reactor, formaldehyde aqueous solution with a concentration of 85% by weight and methylal are supplied with keeping the molar ratio of formaldehyde in the formaldehyde aqueous solution to methylal at 3.5:1, a nitrogen atmosphere is maintained, with catalytic action of strong acidic styrene type cation exchange resin, the reaction is carried out at an inlet temperature of 70-85° C., an outlet temperature of 85-100° C., a pressure of 0.5 MPa, and a space velocity of 2 h⁻¹, until reaction equilibrium is reached.

### Embodiment 4

In a multitubular fixed bed reactor, formaldehyde aqueous solution with a concentration of 85% by weight and methylal are supplied with keeping the molar ratio of formaldehyde in the formaldehyde aqueous solution to methylal at 1:1, a nitrogen atmosphere is maintained, with catalytic action of ZSM-5 catalyst, the reaction is carried out at a temperature of 100-120° C., a pressure of 2 MPa, and a space velocity of 4 h⁻¹, until reaction equilibrium is reached.

### Embodiment 5

In an adiabatic fixed bed reactor, formaldehyde aqueous solution with a concentration of 85% by weight and methylal are supplied with keeping the molar ratio of formaldehyde in the formaldehyde aqueous solution to methylal at 4:1, a nitrogen atmosphere is maintained, with catalytic action of strong acidic styrene type cation exchange resin, the reaction is carried out at an inlet temperature of 90-100° C., an outlet temperature of 100-120° C., a pressure of 1 MPa, and a space velocity of 2.5 h⁻¹, until reaction equilibrium is reached.

### Embodiment 6

In a multitubular fixed bed reactor, formaldehyde aqueous solution with a concentration of 85% by weight and methylal are supplied with keeping the molar ratio of formaldehyde in the formaldehyde aqueous solution to methylal at 4:1, a nitrogen atmosphere is maintained, with catalytic action of HY molecular sieve, the reaction is carried out at a temperature of 120-150° C., a pressure of 1 MPa, and a space velocity of 3 h⁻¹, until reaction equilibrium is reached.

### Embodiment 7

In a multitubular fixed bed reactor, formaldehyde aqueous solution with a concentration of 37% by weight and methylal are supplied with keeping the molar ratio of formaldehyde in the formaldehyde aqueous solution to methylal at 4:1, a nitrogen atmosphere is maintained, with catalytic action of HY molecular sieve, the reaction is carried out at a temperature of 180-200° C., a pressure of 0.1 MPa, and a space velocity of 0.5 h⁻¹, until reaction equilibrium is reached.

### Embodiment 8

In a multitubular fixed bed reactor, formaldehyde aqueous solution with a concentration of 45% by weight and methylal are supplied with keeping the molar ratio of formaldehyde in the formaldehyde aqueous solution to methylal at 4:1, a nitrogen atmosphere is maintained, with catalytic action of HY molecular sieve, the reaction is carried out at a temperature of 180-200° C., a pressure of 0.1 MPa, and a space velocity of 0.5 h⁻¹, until reaction equilibrium is reached.

### Embodiment 9

In a multitubular fixed bed reactor, feedstock formaldehyde aqueous solution with a concentration of 65% by weight and methylal are supplied with keeping the molar ratio of formaldehyde in the formaldehyde aqueous solution to methylal at 4:1, a nitrogen atmosphere is maintained, with catalytic action of HY molecular sieve, the reaction is carried out at a temperature of 180-200° C., a pressure of 0.1 MPa, and a space velocity of 0.5 h⁻¹, until reaction equilibrium is reached.

### Embodiment 10

In a tank reactor, paraformaldehyde and methylal are supplied with keeping the molar ratio of paraformaldehyde to methylal at 4:1, a nitrogen atmosphere is maintained, with catalytic action of HY molecular sieve, the reaction is carried out at a temperature of 180-200° C., and a pressure of 0.1 MPa, until reaction equilibrium is reached after 3 hours of reaction.

The results shown in Table 1 is obtained by measuring the content of polyoxymethylene dimethyl ethers with various polymerization degrees contained in the products obtained after reaction equilibrium is reached in the above-mentioned Embodiments 1-10.

TABLE 1
content (%) of DMM₂₋₈ components in the equilibrium reaction products

| | DMM₂ | DMM₃ | DMM₄ | DMM₅₋₈ | DMM_{>8} | ΣDMM₂₋₈ |
|---|---|---|---|---|---|---|
| Embodiment 1 | 26.01 | 12.55 | 6.42 | 6.53 | 0.23 | 51.74 |
| Embodiment 2 | 25.12 | 12.95 | 6.86 | 6.52 | 0.19 | 51.45 |
| Embodiment 3 | 25.73 | 12.66 | 6.41 | 6.58 | 0.21 | 51.59 |
| Embodiment 4 | 24.88 | 12.24 | 6.33 | 6.46 | 0.21 | 50.12 |
| Embodiment 5 | 25.26 | 12.24 | 6.56 | 6.61 | 0.19 | 50.67 |
| Embodiment 6 | 24.91 | 12.19 | 6.51 | 6.45 | 0.17 | 50.23 |
| Embodiment 7 | 13.63 | 6.71 | 3.05 | 3.6 | 0.05 | 27.04 |
| Embodiment 8 | 14.66 | 7.21 | 4.08 | 4.23 | 0.08 | 30.26 |
| Embodiment 9 | 16.05 | 8.62 | 5.41 | 6.04 | 0.11 | 36.23 |
| Embodiment 10 | 22.11 | 10.86 | 6.17 | 6.75 | 0.22 | 46.11 |

Thus it can be seen that, as compared with the route of using paraformaldehyde as feedstock in prior art, the method of the present invention significantly shortens the reaction time required to reach reaction equilibrium, and helps to drive the forward reaction, thereby increasing the reaction yield rate. Meanwhile, the concentration limitation of the concentrated formaldehyde aqueous solution is carefully selected to further increase the yield rate of the target product, so that the content of effective product is higher.

Apparently, the aforementioned embodiments are merely examples illustrated for clearly describing the present invention, rather than limiting the implementation ways thereof. For those skilled in the art, various changes and modifications in other different forms can be made on the basis of the aforementioned description. It is unnecessary and impossible to exhaustively list all the implementation ways herein. However, any obvious changes or modifications derived from the aforementioned description are intended to be embraced within the protection scope of the present invention.

1. A method for producing polyoxymethylene dimethyl ethers from feedstock of concentrated formaldehyde aqueous solution, comprising:
using concentrated formaldehyde aqueous solution with a concentration of over 80% by weight as feedstock to react with methanol and/or methylal, in the presence of an acidic catalyst, to produce the required polyoxymethylene dimethyl ethers.

2. The method in accordance with claim 1, wherein, the concentration of formaldehyde in the concentrated formaldehyde aqueous solution is 85% by weight.

3. The method in accordance with claim 2, wherein, the concentrated formaldehyde aqueous solution is an intermediate product obtained before a spray drying granulation step during manufacturing of paraformaldehyde.

4. The method in accordance with claim 1, wherein, the reaction for producing polyoxymethylene dimethyl ethers is carried out in a fixed bed reactor.

5. The method in accordance with claim 4, wherein, the fixed bed reactor is an adiabatic reactor or a multitubular reactor.

6. The method in accordance with claim 1, wherein, the acidic catalyst is selected from the group consisting of strong acidic cation exchange resin, solid acid catalyst, and molecular sieve based catalyst.

7. The method in accordance with claim 1, wherein, the reaction is carried out at a temperature of 70-200° C., a pressure of 0.1-2.0 MPa, and a space velocity of 0.5-4.0 h⁻¹.

8. The method in accordance with claim 1, wherein, the molar ratio of the methanol and/or methylal to the formaldehyde in the concentrated formaldehyde aqueous solution is 1:1 to 1:4.

9. The method in accordance with claim 1, wherein, the reaction is carried out under protection of an inert gas.

10. The method in accordance with claim 1, wherein, the reaction further comprises refining the polyoxymethylene dimethyl ether products.

11. The method in accordance with claim 2, wherein, the reaction for producing polyoxymethylene dimethyl ethers is carried out in a fixed bed reactor.

12. The method in accordance with claim 3, wherein, the reaction for producing polyoxymethylene dimethyl ethers is carried out in a fixed bed reactor.

13. The method in accordance with claim 2, wherein, the acidic catalyst is selected from the group consisting of strong acidic cation exchange resin, solid acid catalyst, and molecular sieve based catalyst.

14. The method in accordance with claim 3, wherein, the acidic catalyst is selected from the group consisting of strong acidic cation exchange resin, solid acid catalyst, and molecular sieve based catalyst.

15. The method in accordance with claim 4, wherein, the acidic catalyst is selected from the group consisting of strong acidic cation exchange resin, solid acid catalyst, and molecular sieve based catalyst.

16. The method in accordance with claim 5, wherein, the acidic catalyst is selected from the group consisting of strong acidic cation exchange resin, solid acid catalyst, and molecular sieve based catalyst.

17. The method in accordance with claim 2, wherein, the reaction is carried out at a temperature of 70-200° C., a pressure of 0.1-2.0 MPa, and a space velocity of 0.5-4.0 h⁻¹.

18. The method in accordance with claim 3, wherein, the reaction is carried out at a temperature of 70-200° C., a pressure of 0.1-2.0 MPa, and a space velocity of 0.5-4.0 h⁻¹.

19. The method in accordance with claim 4, wherein, the reaction is carried out at a temperature of 70-200° C., a pressure of 0.1-2.0 MPa, and a space velocity of 0.5-4.0 h⁻¹.

20. The method in accordance with claim 5, wherein, the reaction is carried out at a temperature of 70-200° C., a pressure of 0.1-2.0 MPa, and a space velocity of 0.5-4.0 h⁻¹.
